(19) United States
(12) Patent Application Publication
(10) Pub. No.: US 2024/0185391 A1
(43) Pub. Date: Jun. 6, 2024

(54) LEARNING APPARATUS, LEARNING METHOD AND LEARNING PROGRAM

(71) Applicant: NIPPON TELEGRAPH AND TELEPHONE CORPORATION, Tokyo (JP)

(72) Inventors: Shota YAMADA, Musashino-shi, Tokyo (JP); Hirokazu KAKINUMA, Musashino-shi, Tokyo (JP); Hidenobu NAGATA, Musashino-shi, Tokyo (JP)

(73) Assignee: NIPPON TELEGRAPH AND TELEPHONE CORPORATION, Tokyo (JP)

(21) Appl. No.: 18/285,656

(22) PCT Filed: Apr. 7, 2021
(86) PCT No.: PCT/JP2021/014731

§ 371 Date: Oct. 5, 2023

(51) Int. Cl. G06T 5/50

(52) U.S. Cl. CPC G06T 5/50; G06T 2207/20081

(57) ABSTRACT

According to an embodiment, a learning device includes a data input unit, a feature extraction unit, and a relighted image generation unit. The data input unit acquires an input image and a lighting environment desired to be reflected as a lighting environment of a relighted image. The feature extraction unit extracts a feature quantity of an image structure of the input image from the input image. The relighted image generation unit generates a relighted image, based on pre-learning of a large-scale data set of an image and a lighting environment, from the extracted feature quantity of the image structure of the input image and the acquired lighting environment desired to be reflected.

### TECHNICAL FIELD

The present invention relates to a learning device, a learning method, and a learning program.

### BACKGROUND ART

Relighting is a technology of generating a relighted image in which the lighting environment in the image is changed to a desired one with respect to the input image. In recent years, a relighting technology using a deep layer generation model has been proposed. For example, in Non Patent Literature 1, an encoder/decoder model is used as a structure of a deep layer generation model. That is, in the relighting technology of Non Patent Literature 1, an encoder extracts a feature of an input image in each layer using an image as an input, and a decoder acquires the feature extracted in each layer of the encoder using a lighting environment as an input and reconfigures the image, thereby generating a relighted image different only in the lighting environment.

In addition to the relighting, various technologies for generating various images from the input image have been proposed. For example, Non Patent Literature proposes a technology of embedding an input image in a latent space of an image generation unit learned with a large-scale data set to generate an image subjected to high resolution, face orientation conversion, and the like.

### CITATION LIST

### Non Patent Literature

Non Patent Literature 1: T. SUN, et al, “Single Image Portrait Relighting,” SIGGRAPH2019.
Non Patent Literature 2: E. Richardson, et al, “Encoding in Style: a StyleGAN Encoder for Image-to-Image Translation,” arxiv2008:00951.

### SUMMARY OF INVENTION

### Technical Problem

In the relighting technology, the image structure does not change between the input image and the output image, and only the lighting environment of the entire image changes. In the deep layer generation model as disclosed in Non Patent Literature 1, the high-resolution feature extracted in the shallow layer of the encoder is easily learned as a feature having a large contribution for reconfiguring the image structure. On the other hand, the low-resolution feature extracted in the deep layer of the encoder is used to generate how the entire image is lighted, but is easily learned as a feature having a small contribution for reconfiguring the image structure. Therefore, when an image with shadows or highlights is input to the learned deep layer generation model, shadows or highlights generated by the lighting environment of the input image originally desired to be removed remain. That is, it is difficult to realize image generation without such shadows or highlights only with a shallow layer of the encoder.

In addition, also when a method of embedding an input image in a latent space and acquiring a latent space vector as disclosed in Non Patent Literature 2 is applied to a relighting technology, it is difficult to perform an operation to change only the lighting environment among the obtained latent space vectors.

An object of the present invention is to provide a technology capable of suppressing influence of shadows or highlights in an input image generated by a lighting environment on a generated relighted image.

### Solution to Problem

In order to solve the above problem, a learning device according to an aspect of the present invention includes a data input unit, a feature extraction unit, and a relighted image generation unit. The data input unit acquires an input image and a lighting environment desired to be reflected as a lighting environment of a relighted image. The feature extraction unit extracts a feature quantity of the input image from the input image. The relighted image generation unit generates a relighted image, based on pre-learning of a large-scale data set of an image and a lighting environment, from the extracted feature quantity of the image structure of the input image and the acquired lighting environment desired to be reflected.

### Advantageous Effects of Invention

According to an aspect of the present invention, it is possible to provide a technology capable of suppressing influence of shadows or highlights in an input image generated by a lighting environment on a generated relighted image.

### BRIEF DESCRIPTION OF DRAWINGS

FIG. 1 is a block diagram illustrating an example of a configuration of a deep layer generation model learning system including a learning device according to an embodiment of the present invention.

FIG. 2 is a diagram illustrating an example of a hardware configuration of the learning device.

FIG. 3 is a flowchart illustrating an example of a processing operation of the learning device.

FIG. 4 is a diagram illustrating an example of an input image.

FIG. 5 is a diagram illustrating an example of an estimated lighting environment.

FIG. 6 is a diagram illustrating an example of a lighting environment of a training image.

FIG. 7 is a view illustrating an example of a relighted image.

### DESCRIPTION OF EMBODIMENTS

Hereinafter, an embodiment according to the present invention will be described with reference to the drawings.

### Configuration Example

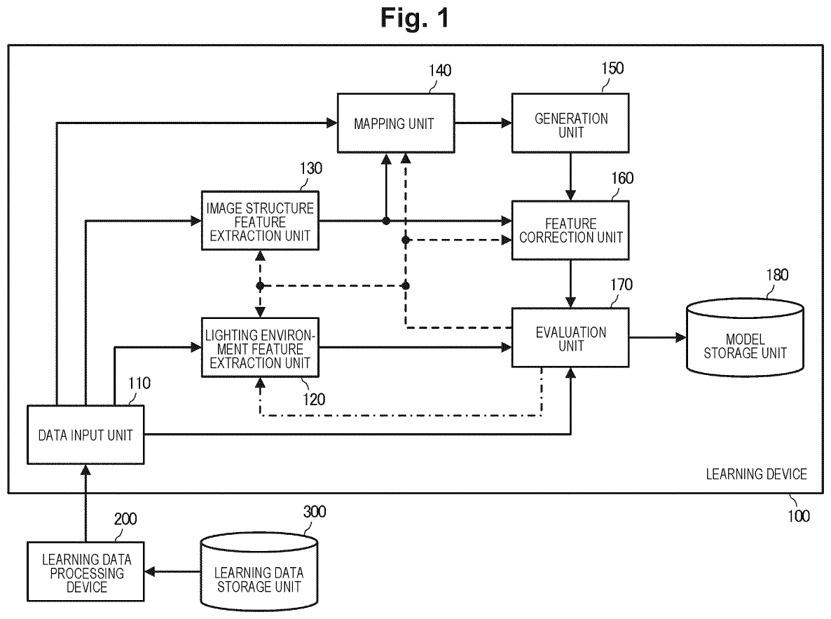

FIG. 1 is a block diagram illustrating an example of a configuration of a deep layer generation model learning system including a learning device 100 according to an embodiment of the present invention. A deep layer generation model learning system includes the learning device 100, a learning data processing device 200, and a learning data storage unit 300. Note that, in the deep layer generation model learning system, these units may be integrally configured as one device or a housing, or may be configured by a plurality of devices. In addition, a plurality of devices may be remotely disposed and connected via a network.

The learning data storage unit 300 stores learning data necessary for learning in the learning device 100. The learning data includes a training image acquired in the lighting environment desired to be reflected as the lighting environment of the relighted image, and the lighting environment of the training image which is the lighting environment desired to be reflected, and the input image acquired in the lighting environment different from the lighting environment of the training image, and is prepared in advance by a user. The training data may include the lighting environment of the input image. Among the training data, the lighting environment can be, for example, vector data using spherical harmonics. It is assumed that one epoch is for transferring all the prepared learning data from the learning data storage unit 300 to the learning data processing device 200 once, and the learning data storage unit 300 randomly rearranges the order of the learning data in each epoch and transfers the learning data to the learning data processing device 200.

The learning data processing device 200 preprocesses the learning data acquired from the learning data storage unit 300. The learning data processing device 200 passes the preprocessed learning data to the learning device 100.

The learning device 100 learns the deep layer generation model by using the learning data transferred from the learning data processing device 200.

In addition, the learning device 100 inputs the learning data acquired from the learning data processing device 200 to the deep layer generation model and generates the relighted image using the deep layer generation model. Then, the learning device 100 evaluates the generated relighted image using the learning data, and updates the parameter of the deep layer generation model and records the deep layer generation model according to the evaluation result.

As illustrated in FIG. 1, the learning device 100 includes a data input unit 110, a lighting environment feature extraction unit 120, an image structure feature extraction unit 130, a mapping unit 140, a generation unit 150, a feature correction unit 160, an evaluation unit 170, and a model storage unit 180.

The data input unit 110 acquires the learning data, that is, the input image, the training image, and the lighting environment of the training image from the learning data processing device 200. The learning data may include the lighting environment of the input image. The data input unit 110 passes the input image of the learning data to the image structure feature extraction unit 130 and passes the training image to the lighting environment feature extraction unit 120. The data input unit 110 may pass the input image instead of the training image to the lighting environment feature extraction unit 120. In addition, the data input unit 110 passes the lighting environment of the training image to the mapping unit 140, and passes the training image and the lighting environment of the training image to the evaluation unit 170. When the input image is passed to the lighting environment feature extraction unit 120, the data input unit 110 passes the lighting environment of the input image to the evaluation unit 170.

The lighting environment feature extraction unit 120 has a multilayer encoder, and extracts a feature quantity for estimating the lighting environment of the input image based on the input image. The number of layers of the encoder and the processing in the layers can be set by the user. Furthermore, in the final layer of the encoder, an encoder that converts to the same format as the lighting environment of the input image is added. In the present embodiment, the lighting environment feature extraction unit 120 acquires a training image or an input image from the data input unit 110, and extracts a feature quantity and estimates a lighting environment by an encoder. The lighting environment feature extraction unit 120 passes the output of the encoder of the final layer to the evaluation unit 170 as the estimated lighting environment.

The image structure feature extraction unit 130 has a multilayer encoder, and extracts a feature quantity of an image structure of an input image, for example, a feature quantity for estimating a shape and/or texture. The number of layers of the encoder and the processing in the layers can be set by the user. In the present embodiment, the image structure feature extraction unit 130 acquires an input image from the data input unit 110, and performs feature extraction in each layer of the encoder. Between the layers of each encoder, the resolution of the feature quantity is reduced to ½ vertically and horizontally, and the feature quantities in each layer are stacked. Hereinafter, a feature group obtained by stacking feature quantities of image structures in each layer of the encoder is referred to as a “feature group A”. The image structure feature extraction unit 130 passes the feature group A to the mapping unit 140.

The mapping unit 140 includes a plurality of encoders depending on the number of layers of the generation unit 150, and each encoder converts the input data into a vector representing a latent space of the generation unit 150. By default, the mapping unit 140 has a number of encoders twice the number of layers of the generation unit 150. In the present embodiment, the mapping unit 140 acquires the lighting environment of the training image from the data input unit 110 and the feature group A in which the feature quantities in the respective layers are stacked from the image structure feature extraction unit 130. Then, the mapping unit 140 acquires a latent space vector by embedding, in the latent space of the image generation model learned with the large-scale data set, a feature quantity obtained by reflecting a condition vector expressing a lighting environment in which relighting is performed, which is indicated by the lighting environment of the training image acquired from the data input unit 110, in the feature quantity of the image structure acquired from the image structure feature extraction unit 130. That is, the mapping unit 140 regards the acquired lighting environment as a condition vector, and expands the acquired lighting environment to match the resolution of the feature quantity of the image structure of each layer to create the feature quantity obtained (or combined) by taking the element product. The mapping unit 140 inputs the feature quantity of the image structure conditioned by the created lighting environment to each encoder included in the mapping unit 140, converts the feature quantity into a latent space vector that is a vector expressing the latent space by each encoder, and stacks the converted latent space vectors. Then, the mapping unit 140 passes the stacked latent space vector group to the generation unit 150.

The generation unit 150 has a multilayer generator, and generates an image using the latent space vector as an input. For example, the generator uses a deep layer generation model obtained by pre-learning a task of generating only a target to be relighted using a large-scale data set such as StyleGAN2. In the present embodiment, the generation unit 150 acquires the latent space vector group from the mapping unit 140. Then, the generation unit 150 inputs the latent space vector corresponding to each layer of the generator from the acquired vector group, generates the feature quantity of the image structure in each layer of the generator, and stacks the feature quantity of the generated image structure. Hereinafter, a feature group in which feature quantities of image structures generated in the respective layers of the generator are stacked is referred to as a “feature group B”. The generation unit 150 passes the feature group B to the feature correction unit 160. Note that the feature quantity of the feature group B is not divided into the feature quantity of the image structure and the feature quantity of the lighting environment. Furthermore, the generation unit 150 generates a relighted image by converting the feature quantity having the highest resolution of the feature group B into an RGB color space, and passes the generated relighted image to the feature correction unit 160.

The feature correction unit 160 includes a multilayer decoder and generates a corrected relighted image obtained by correcting the relighted image. In the present embodiment, the feature correction unit 160 acquires the feature group A, in which feature quantities of image structures in the respective layers of the encoder are stacked, from the image structure feature extraction unit 130, the feature group B, in which feature quantities in the respective layers of the generator are stacked, from the generation unit 150, and the relighted image. The feature correction unit 160 selects a feature quantity having the lowest resolution (feature quantity in the final layer) in the acquired feature group A, and for the feature group B, selects a feature quantity having the same resolution as the feature quantity selected for the feature group A. Then, the feature correction unit 160 uses the feature quantity obtained by combining the selected feature quantities as an input to the decoder. The feature correction unit 160 enlarges the resolution of the feature quantity twice vertically and horizontally between the layers of each decoder, combines the feature quantity with the feature quantities in the feature group A and the feature group B equal to the resolution, and uses the feature quantity as an input to the next layer of the decoder. The feature correction unit 160 passes the relighted image to the evaluation unit 170, and passes the relighted image obtained by converting the feature quantity output from the final layer of the decoder into the RGB color space to the evaluation unit 170 as a corrected relighted image. The corrected relighted image is a final relighted image obtained by correcting the relighted image generated by the generation unit 150.

The evaluation unit 170 updates the parameters of the image structure feature extraction unit 130, the lighting environment feature extraction unit 120, the mapping unit 140, and the feature correction unit 160 using an optimization method to minimize an error between the estimated lighting environment, the relighted image, the corrected relighted image, and the training data. In the present embodiment, the evaluation unit 170 acquires the estimated lighting environment from the lighting environment feature extraction unit 120, and acquires the relighted image and the corrected relighted image from the feature correction unit 160. Further, the evaluation unit 170 acquires the training image and the lighting environment of the training image from the data input unit 110. Furthermore, in a case where the lighting environment feature extraction unit 120 estimates the lighting environment of the input image, the evaluation unit 170 acquires the lighting environment of the input image from the data input unit 110. Then, the evaluation unit 170 calculates, from the error function, an error between the estimated lighting environment and the lighting environment of the training image or the lighting environment of the input image, and an error between each of the relighted image and the corrected relighted image and the training image. The error function uses an L1 norm or an L2 norm. In addition, as an option, the L1 norm or the L2 norm of the feature calculated by an encoder used in existing image classification such as VGG, an encoder used for identification of the same person such as ArcFace, or the like may be added for the error between each of the relighted image and the corrected relighted image and the training image. Thereafter, using an optimization method designated in any manner by the user from the calculated error, the evaluation unit 170 obtains the gradient of the parameter of each of the lighting environment feature extraction unit 120, the image structure feature extraction unit 130, the mapping unit 140, and the feature correction unit 160 to minimize these errors, and updates each parameter. At this time, the parameters may be updated such that each error is treated equally and each error is minimized on average, or the parameters may be updated such that the error to be prioritized the most is minimized by giving a weight between the errors. Note that the generation unit 150 does not update the parameter. Finally, the evaluation unit 170 passes the parameters of the deep layer generation model that has learned the training image, the input image, and the corrected relighted image to the model storage unit 180.

The model storage unit 180 has parameters of the learned deep layer generation model. The model storage unit 180 acquires the parameters of the deep layer generation model from the evaluation unit 170 in the epoch, and stores the acquired parameters of the deep layer generation model as a file.

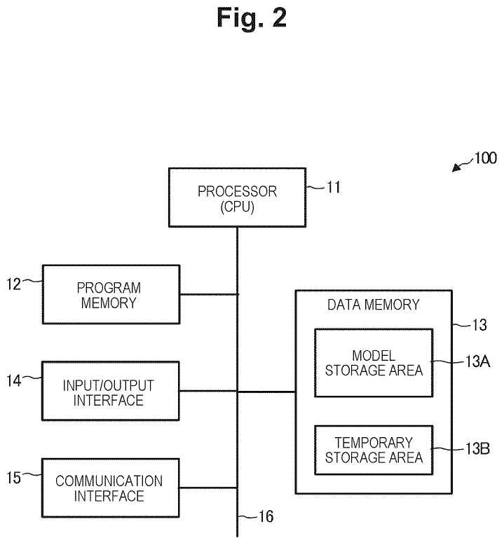

FIG. 2 is a diagram illustrating an example of a hardware configuration of the learning device 100. The learning device 100 includes, for example, a processor 11, a program memory 12, a data memory 13, an input/output interface 14, and a communication interface 15. Then, a program memory 12, a data memory 13, an input/output interface 14, and a communication interface 15 are connected to the processor 11 via a bus 16. The learning device 100 may be configured by, for example, a general-purpose computer such as a personal computer.

The processor 11 includes a multi-core multi-thread number of central processing units (CPU), and can simultaneously execute a plurality of pieces of information processing in parallel.

The program memory 12 is used as a storage medium, for example, in a combination of a non-volatile memory that can be written and read at any time, such as a hard disk drive (HDD) or a solid state drive (SSD), and a non-volatile memory such as a read only memory (ROM), and thus as the processor 11 such as a CPU is executed, the program memory 12 stores programs necessary for executing various control processing according to one embodiment of the present invention. That is, the processor 11 can function as the data input unit 110, the image structure feature extraction unit 130, the lighting environment feature extraction unit 120, the mapping unit 140, the generation unit 150, the feature correction unit 160, and the evaluation unit 170 as illustrated in FIG. 1 by reading and executing a program stored in the program memory 12, for example, a learning program. Note that these processing functional units may be realized by sequential processing of one CPU thread, or may be realized in a form in which simultaneous parallel processing can be performed by separate CPU threads. In addition, these processing functional units may be realized by separate CPUs. That is, the learning data processing device 200 may include a plurality of CPUs. In addition, at least some of these processing functional units may be realized in the form of other various hardware circuits including an integrated circuit such as an application specific integrated circuit (ASIC), a field-programmable gate array (FPGA), or a graphics processing unit (GPU).

The data memory 13 uses, as a storage medium, for example, a combination of a non-volatile memory that can be written and read as needed, such as an HDD or an SSD, and a volatile memory such as a random access memory (RAM), and is used to store various data necessary for performing learning processing. For example, a model storage area 13A for storing parameters of the learned deep layer generation model can be secured in the data memory 13. That is, the data memory 13 can function as the model storage unit 180. In addition, in the data memory 13, a temporary storage area 13B used to store various data acquired and created in the process of performing the learning processing can also be secured.

The input/output interface 14 is an interface with an input device such as a keyboard and a mouse (not illustrated) and an output device such as a liquid crystal monitor. Furthermore, the input/output interface 14 may include an interface with a reader/writer of a memory card or a disk medium.

The communication interface 15 includes, for example, one or more wired or wireless communication interface units, and enables transmission and reception of various types of information with a device on a network according to a communication protocol used in the network. As the wired interface, for example, a wired LAN, a universal serial bus (USB) interface, or the like is used, and as the wireless interface, for example, a mobile phone communication system such as 4G or 5G, an interface adopting a low-power wireless data communication standard such as a wireless LAN or Bluetooth (registered trademark), or the like is used. For example, in a case where the learning data processing device 200 is disposed in a server device or the like on a network, the processor 11 can receive and acquire the learning data via the communication interface 15.

### (Operation)

Next, an operation of the learning device 100 will be described.

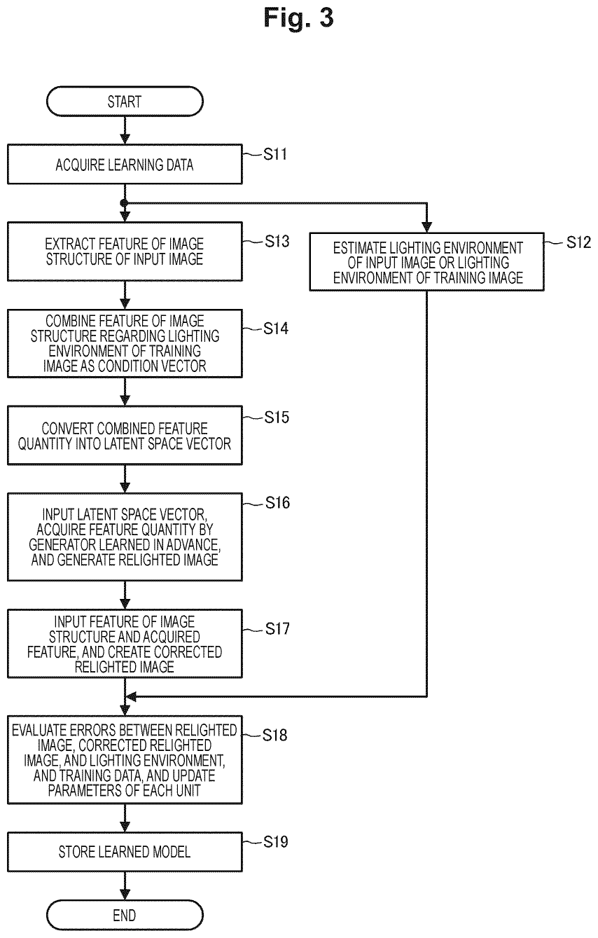

FIG. 3 is a flowchart illustrating an example of a processing operation of the learning device 100. When execution of the learning program is instructed by the user from an input device (not illustrated) via the input/output interface 14, the processor 11 starts the operation illustrated in this flowchart. Alternatively, the processor 11 may start the operation illustrated in this flowchart in response to an execution instruction from the learning data processing device 200 on the network or a user communication device (not illustrated) via the communication interface.

First, the processor 11 executes the operation as the data input unit 110 and acquires the learning data from the learning data processing device 200 (step S11). The acquired learning data is stored in the temporary storage area 13B of the data memory 13. The learning data includes an input image, a training image, and a lighting environment of the training image. Note that the learning data may include the lighting environment of the input image.

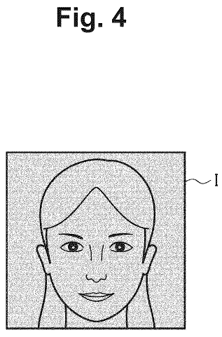

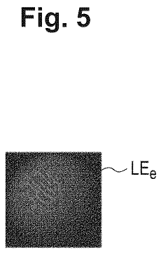

Then, the processor 11 executes an operation as the lighting environment feature extraction unit 120. That is, the processor 11 reads the training image or the input image from the temporary storage area 13B, and estimates the lighting environment of the training image or the lighting environment of the input image from the training image or the input image (step S12). Passing the training image or the input image from the data input unit 110 to the lighting environment feature extraction unit 120 in the above description of the configuration means storage and reading in the temporary storage area 13B in this manner. The same applies to the following description. FIG. 4 is a diagram illustrating an example of an input image I. FIG. 5 is a diagram illustrating an example of an estimated lighting environment LEₑ. The processor 11 stores the estimated lighting environment LEₑ in the temporary storage area 13B.

In addition, the processor 11 executes the operation as the image structure feature extraction unit 130 simultaneously in parallel with the processing in step S12. That is, the processor 11 reads an input image I from the temporary storage area 13B, and extracts, from the input image I, a feature quantity for estimating a shape and/or texture, which is a feature quantity of an image structure of the input image I (step S13). The processor 11 stores the feature group A in which the feature quantities of the extracted image structures are stacked in the temporary storage area 13B.

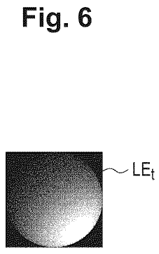

Subsequently, the processor 11 executes the operation as the mapping unit 140, reads the feature group A in which the lighting environment and the feature quantity of the training image are stacked from the temporary storage area 13B, and combines the feature group A with the feature quantity of the image structure (step S14). The lighting environment of the training image is a lighting environment desired to be reflected. FIG. 6 is a diagram illustrating an example of a lighting environment LEₜ of a training image. Then, the processor 11 converts the combined feature quantity into a latent space vector (step S15). The processor 11 stores a vector group in which the converted latent space vectors are stacked in the temporary storage area 13B.

Next, the processor 11 executes the operation as the generation unit 150, reads a vector group in which latent space vectors are stacked from the temporary storage area 13B, and acquires a feature quantity by a generator learned in advance using the vector group as an input (step S16). The processor 11 acquires the feature group B obtained by stacking the acquired feature quantities. In addition, the processor 11 generates the relighted image by converting the feature quantity having the highest resolution of the feature group B into the RGB color space. Then, the processor 11 stores the acquired feature group B and the generated relighted image in the temporary storage area 13B.

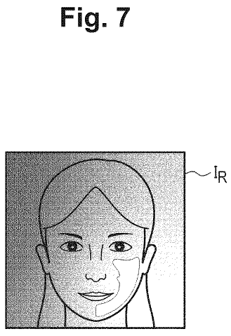

Then, the processor 11 executes the operation as the feature correction unit 160, reads the feature group A and the feature group B from the temporary storage area 13B, and creates the corrected relighted image using the feature quantities of the feature group A and the feature group B as inputs (step S17). FIG. 7 is a diagram illustrating an example of a created corrected relighted image I_{R}. Note that, in the drawing, a frame line is described on the cheek part of a face of a person, but this is merely described to facilitate identification of a brightly lighted part, and such a frame line does not occur in the actual corrected relighted image I_{R}. The processor 11 stores the created corrected relighted image I_{R} in the temporary storage area 13B.

As described above, when the relighted image and the corrected relighted image I_{R} and the estimated lighting environment LEₑ are temporarily stored in the temporary storage area 13B, the processor 11 executes the operation as the evaluation unit 170. That is, the processor 11 reads the relighted image, the corrected relighted image I_{R}, the estimated lighting environment LEₑ, the training image, and the lighting environment LEₜ of the training image or the lighting environment of the input image from the temporary storage area 13B. Then, the processor 11 evaluates errors between the relighted image, the corrected relighted image I_{R} and the estimated lighting environment, and the training data, that is, the training image, and the lighting environment of the training image or the lighting environment of the input image, and updates the parameters of the image structure feature extraction unit 130, the lighting environment feature extraction unit 120, the mapping unit 140, and the feature correction unit 160 (step S18). The parameters of each unit are stored in, for example, the non-volatile memory in the program memory 12 or the data memory 13.

In addition, the processor 11 stores the parameters of the deep layer generation model that has learned the training image, the input image I, and the corrected relighted image I_{R} in the model storage unit 180 (step S19).

As described above, the learning device 100 ends the learning processing operation in one epoch.

In the learning device 100 according to the embodiment described above, the data input unit 110 acquires the input image and the lighting environment of the training image that is the lighting environment desired to be reflected as the lighting environment of the relighted image, and the image structure feature extraction unit 130, that is, the feature extraction unit extracts the feature quantity of the image structure of the input image from the input image. Then, the mapping unit 140 and the generation unit 150, which are the relighted image generation unit, generate the relighted image based on the pre-learning of the large-scale data set of the image and the lighting environment from the feature quantity of the image structure of the extracted input image and the acquired lighting environment desired to be reflected.

As described above, the learning device 100 according to one embodiment separates the feature quantity of the image structure obtained by excluding the feature quantity of the lighting environment from the input image and generates the relighted image based on the feature quantity of the image structure, and thus, it is possible to suppress influence of the shadows or the highlights in the input image generated by the lighting environment on the generated relighted image.

In addition, according to an embodiment, the relighted image generation unit includes the mapping unit 140 that acquires a latent space vector capable of generating a target in which only the lighting environment is changed, by embedding, in a latent space of an image generation model learned with the large-scale data set, a feature quantity in which a condition vector expressing the lighting environment desired to be reflected is reflected in a feature quantity of an image structure of the input image, and the generation unit 150 that generates the relighted image from the latent space vector using a parameter of the image generation model learned with the large-scale data set.

As described above, the learning device 100 according to the embodiment can acquire the latent space vector capable of generating the target in which only the lighting environment is changed, by embedding the feature quantity reflecting the condition vector expressing the lighting environment in the feature quantity of the image structure, and thus it is possible to easily perform the operation to change only the lighting environment among the obtained latent space vectors.

Furthermore, according to the embodiment, the feature correction unit 160 which is a correction unit that corrects the relighted image generated by the relighted image generation unit based on a feature quantity of an image structure of the extracted input image is further provided.

In the learning device 100 according to an embodiment, by using an image generation model pre-learned with a large-scale data set, it is possible to obtain a relighted image having no influence of shadows or highlights on the input image in consideration of characteristics from high resolution to low resolution. However, since the generated relighted image cannot reproduce the high-definition image structure of the input image such as the hair tip, the eye area, and the like, the learning device 100 according to one embodiment can obtain a corrected relighted image capable of reproducing a high-definition part of the image by performing correction using the feature of the extracted image structure.

In addition, according to the embodiment, the data input unit 110 further acquires a training image acquired in the lighting environment desired to be reflected, the lighting environment feature extraction unit 120 which is the feature extraction unit extracts a feature quantity of a lighting environment of the training image or a feature quantity of a lighting environment of the training image or input image from the input image separately from a feature quantity of an image structure of the input image, and the evaluation unit 170 evaluates an error between the extracted feature quantity of the lighting environment and the feature quantity of the lighting environment desired to be reflected and an error between the feature quantity of the relighted image generated by the generation unit 150 and the feature quantity of the corrected relighted image corrected by the feature correction unit 160 and the feature quantity of the training image, and updates parameters of the lighting environment feature extraction unit 120, the image structure feature extraction unit 130, the mapping unit 140, and the feature correction unit 160.

As described above, the learning device 100 according to the embodiment can update the parameters of each unit according to the evaluation result.

In addition, according to the embodiment, the evaluation unit 170 passes the parameters of the deep layer generation model that has learned the training image, the input image, and the corrected relighted image to the model storage unit 180.

As described above, the learning device 100 according to the embodiment can generate a more appropriate relighted image by further performing learning.

In addition, according to the embodiment, the feature extraction unit includes the image structure feature extraction unit 130 that extracts a feature quantity of an image structure of an input image, which is an input image, and the lighting environment feature extraction unit 120 that extracts a feature quantity of a lighting environment of a training image or an input image, which is an input image, and the image structure feature extraction unit 130 and the lighting environment feature extraction unit 120 operate simultaneously in parallel.

As described above, in the learning device 100 according to one embodiment, the two feature extraction units perform simultaneous parallel processing, such that the processing speed can be increased.

### Other Embodiments

In the embodiment described above, the relighted image and the corrected relighted image are used for updating the parameters of each unit, but it is needless to say that the corrected relighted image may be output from the learning device 100 as a product. That is, the learning device 100 can function as a relighted image generation device.

In addition, as indicated by a dashed-dotted line arrow in FIG. 1, the evaluation unit 170 may input the corrected relighted image to the lighting environment feature extraction unit 120, add an error between the lighting environment estimated therefrom and the lighting environment of the training image, and perform evaluation.

The function of the learning data processing device 200 may be incorporated in the learning device 100. Furthermore, the learning device 100 may directly read the learning data from the learning data storage unit 300 without passing through the learning data processing device 200.

Furthermore, the learning data storage unit 300 may also be configured as a part of the learning device 100. That is, the data memory 13 may be provided with a storage area as the learning data storage unit 300.

In the embodiment described above, the lighting environment estimation processing in step S12 is performed in parallel with the processing in steps S13 to S17, but the present invention is not limited thereto. The processing of step S12 may be performed before the processing of step S13, after the processing of step S17, or somewhere in the middle of the processing of steps S13 to S17.

Furthermore, the method described in each embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computing machine (computer), and can also be distributed by being transmitted through a communication medium. Note that the programs stored on the medium side also include a setting program for configuring, in the computing machine, a software means (including not only an execution program but also tables and data structures) to be executed by the computing machine. The computing machine that implements the present device executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computing machine or in a device connected via a network.

In short, the present invention is not limited to the above-described embodiments, and various modifications can be made in the implementation stage without departing from the gist thereof. In addition, the embodiments may be implemented in appropriate combination if possible, and in this case, combined effects can be obtained. Furthermore, the above-described embodiments include inventions at various stages, and various inventions can be extracted by appropriate combinations of a plurality of disclosed components.

### REFERENCE SIGNS LIST

11 Processor
12 Program memory
13 Data memory
13A Model storage area
13B Temporary storage area
14 Input/output interface
15 Communication interface
16 Bus
100 Learning device
110 Data input unit
120 Lighting environment feature extraction unit
130 Image structure feature extraction unit
140 Mapping unit
150 Generation unit
160 Feature correction unit
170 Evaluation unit
180 Model storage unit
200 Learning data processing device
300 Learning data storage unit
I Input image
LEₑ Estimated lighting environment
LEₜ Lighting environment of training image
I_{R} Corrected relighted image

1. A learning device comprising:
data input circuitry that acquires an input image and a lighting environment desired to be reflected as a lighting environment of a relighted image;
feature extraction circuitry that extracts a feature quantity of an image structure of the input image from the input image; and
relighted image generation circuitry that generates a relighted image, based on pre-learning of a large-scale data set of an image and a lighting environment, from the extracted feature quantity of the image structure of the input image and the acquired lighting environment desired to be reflected.

2. The learning device according to claim 1, wherein the relighted image generation circuitry includes:
mapping circuitry that acquires a latent space vector capable of generating a target in which only the lighting environment is changed, by embedding, in a latent space of an image generation model learned with the large-scale data set, a feature quantity in which a condition vector expressing the lighting environment desired to be reflected is reflected in the feature quantity of the image structure of the input image, and
generation circuitry that generates the relighted image from the latent space vector using a parameter of the image generation model learned with the large-scale data set.

3. The learning device according to claim 2, further comprising:
correction circuitry that corrects the relighted image generated by the relighted image generation circuitry based on the feature quantity of the image structure of the extracted input image.

4. The learning device according to claim 3, wherein:
the data input circuitry further acquires a training image acquired in the lighting environment desired to be reflected,
the feature extraction circuitry extracts a feature quantity of a lighting environment of the training image or a feature quantity of a lighting environment of the input image from the training image or the input image separately from the feature quantity of the image structure of the input image, and
the learning device further comprises evaluation circuitry that evaluates an error between the extracted feature quantity of the lighting environment and the feature quantity of the lighting environment desired to be reflected and an error between the feature quantity of the relighted image generated by the relighted image generation circuitry and corrected by the correction circuitry and the feature quantity of the training image, and updates parameters of the feature extraction circuitry, the mapping circuitry, and the correction circuitry.

5. The learning device according to claim 4, wherein:
the evaluation circuitry causes a model storage memory to store parameters of a deep layer generation model that has learned the training image, the input image, and the relighted image.

6. The learning device according to claim 1, wherein:
the feature extraction circuitry includes:
image structure feature extraction circuitry that extracts a feature quantity of an image structure of an input image, and
lighting environment feature extraction circuitry that extracts a feature quantity of a lighting environment of an input image, and
the image structure feature extraction circuitry and the lighting environment feature extraction circuitry operate simultaneously in parallel.

7. A learning method, comprising:
acquiring an input image and a lighting environment desired to be reflected as a lighting environment of the relighted image;
extracting a feature quantity of an image structure of the input image from the input image; and
generating a relighted image, based on pre-learning of a large-scale data set of an image and a lighting environment, from the extracted feature quantity of the image structure of the input image and the acquired lighting environment desired to be reflected.

8. A non-transitory computer readable medium storing a learning program for causing a processor to function as each of the circuitries of the learning device according to claim 1.

9. A non-transitory computer readable medium storing a learning program for causing a processor to perform the method of claim 7.
